(19) United States
(12) Patent Application Publication
(10) Pub. No.: US 2011/0176308 A1
(43) Pub. Date: Jul. 21, 2011

(54) ILLUMINATION DEVICE AND LIGHT-EMITTING MODULE THEREOF

(76) Inventors: Hsiang-Chen Wu, Taoyuan Hsien (TW); Chin-Ming Cheng, Taoyuan Hsien (TW)

(21) Appl. No.: 13/009,358

(22) Filed: Jan. 19, 2011

(30) Foreign Application Priority Data
Jan. 20, 2010 (TW) 99101437

(51) Int. Cl. F21V 7/00

(52) U.S. Cl. 362/247

(57) ABSTRACT

An illumination device is provided, including a frame, at least one light-emitting unit, at least one substrate and a heat-dissipating structure. The light-emitting unit is disposed on the substrate. The heat-dissipating structure is disposed in the frame. The heat-dissipating structure includes a recess, wherein the substrate is disposed in the recess, and tightly contacts the heat-dissipating structure by an elastic element.

### CROSS REFERENCE TO RELATED APPLICATIONS

This Application claims priority of Taiwan Patent Application No. 099101437, filed on Apr. 29, 2010, the entirety of which is incorporated by reference herein.

### BACKGROUND OF THE INVENTION

1. Field of the Invention

The present invention relates to an illumination device and a light-emitting module thereof, and in particular relates to an easily assembled illumination device and a light-emitting module with improved heat dissipation.

2. Description of the Related Art

For conventional illumination products utilizing LEDs (light emitting diodes) as a light source, such as a road lamp, wall lamp, desk lamp, light bulb or light tube, heat dissipation is an important issue when designing products, particularly for high power lamps. FIG. 1 shows a light-emitting module of a conventional illumination lamp, comprising a plurality of LEDs 11, a circuit board 12 and a heat-dissipating structure 13. The LEDs 11 are disposed on the circuit board 12. The circuit board 12 is attached to the heat-dissipating structure 13. Holes 121 and 131 are formed on the circuit board 12 and the heat-dissipating structure 13, wherein the holes 121 correspond to the holes 131, and the circuit board 12 and the heat-dissipating structure 13 are fixed together by bolts 14 passing therethrough to tightly contact the circuit board 12 to the heat-dissipating structure 13.

However, the holes 121 on the circuit board must be precisely corresponded to the holes 131 of the heat-dissipating structure. When the holes 121 of the circuit board are not precisely corresponded to the holes 131 of the heat-dissipating structure, a gap g is formed between the circuit board 12 and the heat-dissipating structure 13, and heat dissipation efficiency of the lamp is decreased.

### BRIEF SUMMARY OF THE INVENTION

A detailed description is given in the following embodiments with reference to the accompanying drawings.

The invention provides an easily assembled illumination device and light-emitting module with improved heat dissipation.

A light-emitting module of the embodiment of the invention includes at least one light-emitting unit, a substrate and a heat-dissipating structure. The light-emitting unit provides a light beam and is disposed on the substrate. The heat-dissipating structure includes a recess and at least one protruding portion, wherein the substrate is disposed in the recess, and the protruding portions protrude out from the recess.

The recess includes a bottom portion and a plurality of side walls, and the protruding portions extend from the side walls toward a central portion of the recess. At least one groove is formed among the protruding portion, the bottom portion and the side wall. The substrate is attached to the bottom portion of the recess, and a part of the substrate extends to the groove. The light-emitting module further includes at least one elastic element, disposed in the groove located between the protruding portions and the substrate for fixing the substrate. The elastic element is a circular or elliptic pillar, and made of plastic or rubber. The elastic element includes a bending sheet and a base, and the base is disposed on the substrate, and the bending sheet abuts against the protruding portions of the heat-dissipating structure. The base includes a through hole, and the size of the through hole is substantially the same with that of the bending sheet. The bending sheet is integrally formed with the base, welded to the base, embedded in the base or wedged to the base. The protruding portions include an oblique surface, and the oblique surface tilts from an outer side of the heat-dissipating structure toward a central portion of the heat-dissipating structure to reflect the light beam.

In one embodiment, each protruding portions includes at least one protrusion extending downward from the each of the protruding portions for fixing the substrate, at least one indentation is formed on an upper surface of the protruding portions corresponding to the protrusion, and the protrusion includes a curved or hemispheric surface shape.

The substrate is extended longitudinally. The light-emitting units are arranged separately along a longitudinal direction of the substrate, and the light-emitting units are LEDs. The heat-dissipating structure is an aluminum extrusion heat-dissipating structure, wherein the heat-dissipating structure includes a plurality of heat dissipation fins, and the heat dissipation fins are disposed on two lateral sides of the recess symmetrically, and the heat dissipation fins extend outward parallel to the substrate. The substrate is a print circuit board.

The invention also discloses an illumination device comprising a frame, at least one light-emitting unit, at least one substrate and a heat-dissipating structure. The light-emitting unit is disposed on the substrate. The heat-dissipating structure is disposed in the frame and includes a recess and at least one protruding portion, wherein the substrate is disposed in the recess, and the protruding portions protrude out from the recess. The illumination device further includes a fixer, disposed on an end of the frame opposite to the heat-dissipating structure. The fixer is disposed on an outer portion of the frame, the fixer and the heat-dissipating structure are respectively mounted on both sides of the frame so that the heat-dissipating structure is attached to a bottom of the frame, and the fixer, the frame and the heat-dissipating structure are fastened together by at least a screw. The heat-dissipating structures are extended longitudinally, and are arranged on the frame separately. The heat-dissipating structure and the frame are made of Cu, Al, Fe, magnesium alloy, metal, or high thermal conduction material.

### BRIEF DESCRIPTION OF THE DRAWINGS

The present invention can be more fully understood by reading the subsequent detailed description and examples with references made to the accompanying drawings, wherein:

FIG. 1 shows a light-emitting module of a conventional illumination lamp;

FIG. 2A shows an embodiment of a light-emitting module of the invention;

FIG. 2B is a side view of the embodiment of FIG. 2A;

FIG. 3A shows another embodiment of a light-emitting module of the invention;

FIG. 3B shows an elastic element of the embodiment of FIG. 3A;

FIG. 4A shows another embodiment of a light-emitting module of the invention;

FIG. 4B is a side view of the embodiment of FIG. 4A;

FIG. 5A shows an embodiment of an illumination device of the invention;

FIG. 5B is a sectional view along B-B direction of FIG. 5A; and

FIG. 5C is an enlarged view of portion A of FIG. 5B.

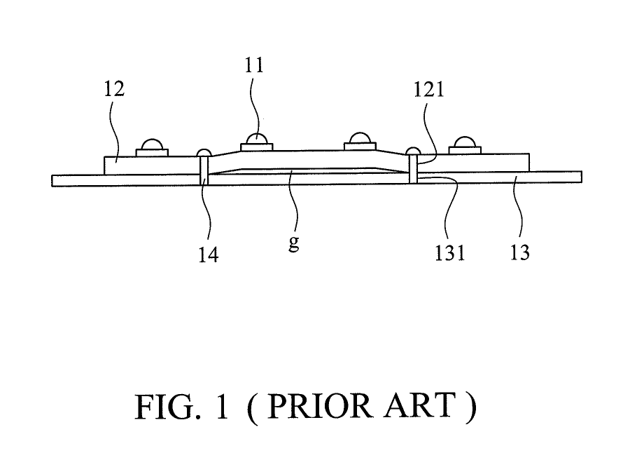

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

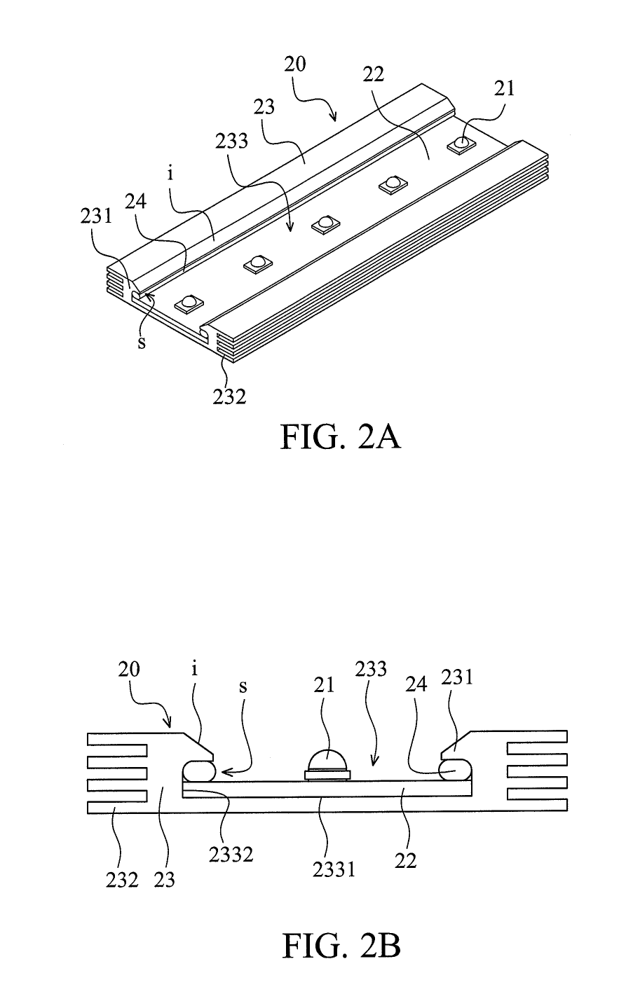

FIGS. 2A and 2B show an embodiment of a light-emitting module of the invention. The light-emitting module 20 includes at least one light-emitting unit 21, a substrate 22 and a heat-dissipating structure 23. The light-emitting units 21 are disposed on the substrate 22. The heat-dissipating structure 23 includes a recess 233. The substrate 22 is disposed in the recess 233.

The heat-dissipating structure 23 includes protruding portions 231. The recess 233 includes a bottom portion 2331 and side walls 2332, and the protruding portions 231 extend from the side wall 2332 horizontally toward a central portion of the recess 233. A groove s is formed among the protruding portion 231, the bottom portion 2331 and the side wall 2332. The substrate 22 is attached to the bottom portion 2331 of the recess 233. A part of the substrate 22 extends into the groove s. The light-emitting module 20 further includes at least one elastic element 24, disposed in the groove s located between the protruding portions 231 and the substrate 22 for fixing the substrate 22. The elastic element 24 can be made of plastic or rubber, and can be a circular or elliptic pillar shape. The protruding portions 231 includes an oblique surface i, which tilts from an outer side of the heat-dissipating structure 23 toward a central portion of the heat-dissipating structure to reflect the light beam emitted from the light-emitting unit 21.

The substrate 22 is extended longitudinally. The light-emitting units 21 are arranged separately along a longitudinal direction of the substrate 22. The heat-dissipating structure 23 includes a plurality of heat dissipation fins 232, the heat dissipation fins 232 are symmetrically disposed on two lateral sides of the recess 233, and the heat dissipation fins 232 extend outward, parallel to the substrate 22.

The light-emitting units 21 can be LEDs. The substrate 22 can be a print circuit board. The heat-dissipating structure can be an integrally formed aluminum extrusion heat-dissipating structure.

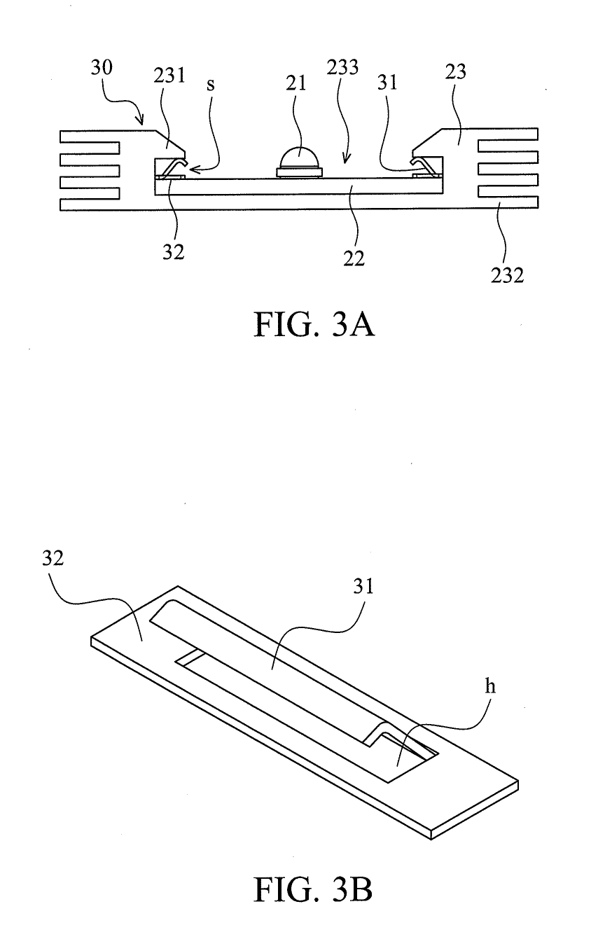

FIGS. 3A and 3B show another embodiment of a light-emitting module of the invention. The elastic element of the light-emitting module 30 can be a rigid elastic structure combined with the bending sheet 31 and the base 32. The base 32 is disposed on the substrate 22. The bending sheet 31 abuts against the protruding portions 231 of the heat-dissipating structure 23. The base 32 includes a through hole h. The size of the through hole h is substantially the same with that of the bending sheet 31.

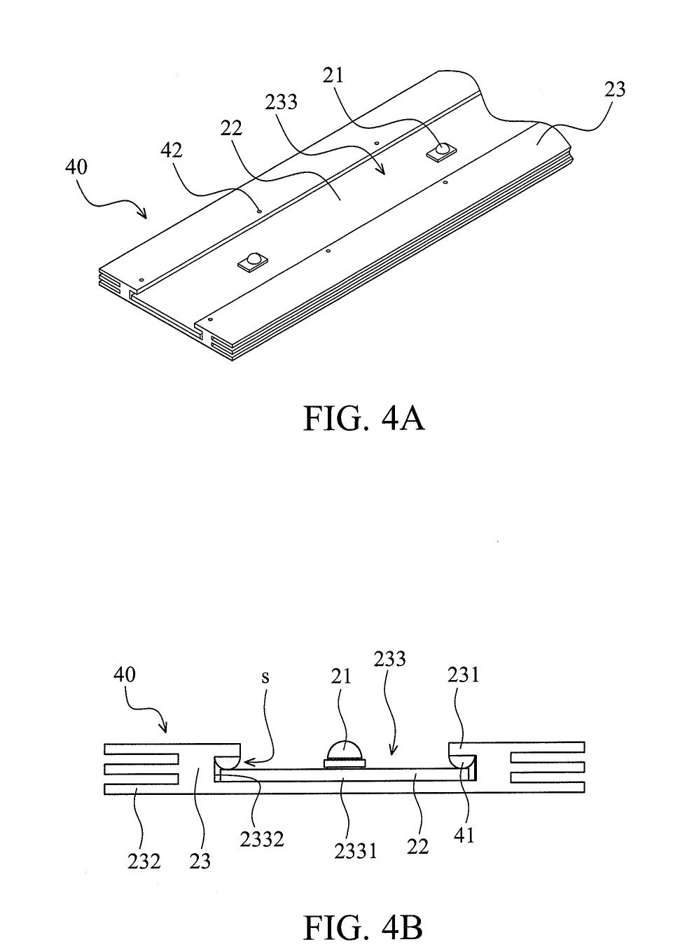

As shown in FIGS. 4A and 4B, protrusions 41 are formed on the protruding portions 231 by punching to fix the substrate. The protrusions 41 extend downward from the each of the protruding portions 231, abutting against the substrate 22 to fix the substrate 22 to the recesses 233 of the heat-dissipating structure 23. Indentations 42 are formed on an upper surface of the protruding portions 231 corresponding to the protrusions 41, and each protrusion 41 includes a curved or hemispheric surface shape.

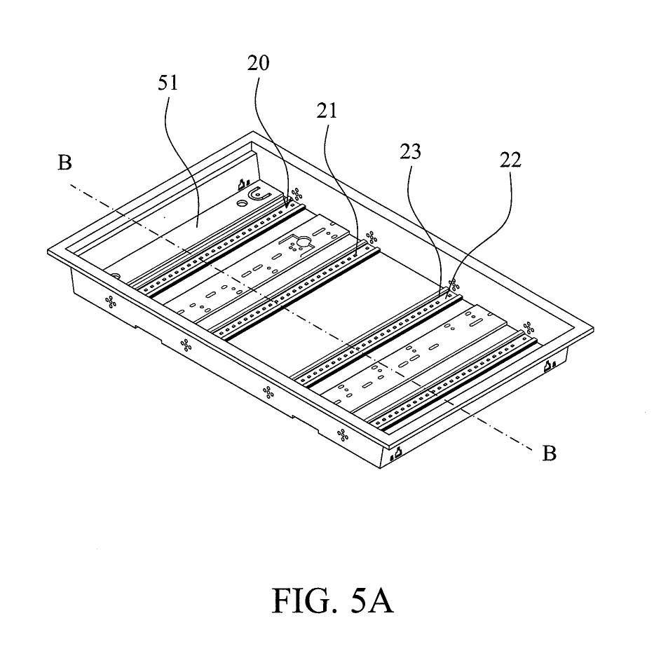

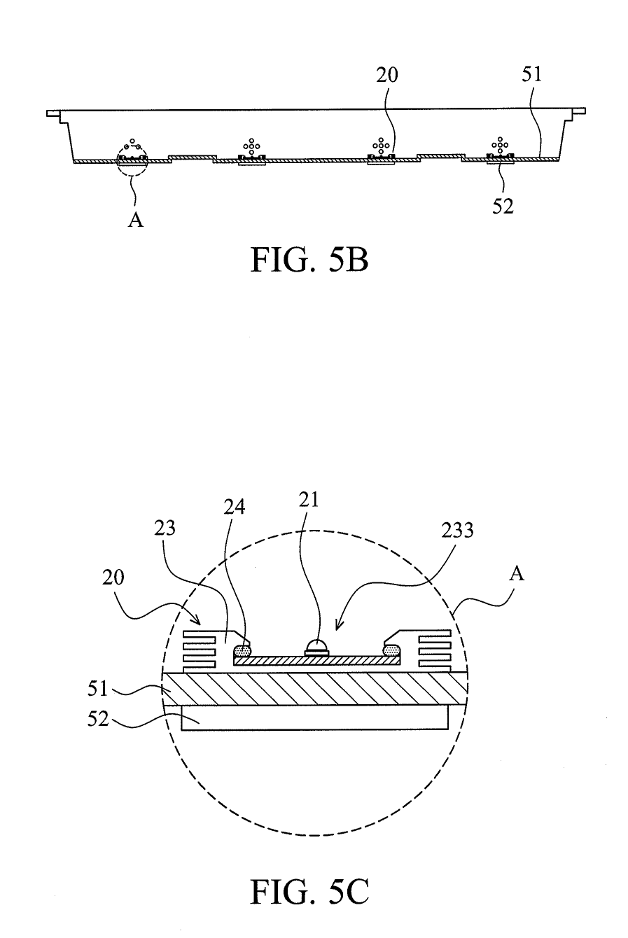

FIGS. 5A to 5C show an embodiment of an illumination device of the invention. FIG. 5B is a sectional view along B-B direction of FIG. 5A. FIG. 5C is an enlarged view of portion A of FIG. 5B. The illumination device includes a frame 51. Light-emitting modules 20 shown in FIG. 2A are disposed in the frame. The light-emitting module 20 includes at least one light-emitting unit 21, at least one substrate 22 and at least one heat-dissipating structure 23. The light-emitting unit 21 is disposed on the substrate 22. The heat-dissipating structure 23 is disposed in the frame 51. The heat-dissipating structure 23 has a recess 233. The substrate 22 is disposed in the recess 233.

The illumination device further includes a fixer 52 disposed on a side of the frame 51 opposite to the heat-dissipating structure 23. The fixer 52 is preferably disposed on an outer portion of the frame 51. The fixer 52 and the heat-dissipating structure 23 respectively press on both sides of the frame 51 to ensure so that the heat-dissipating structure 23 is tightly attached to a bottom of the frame 51 to improve heat dissipation. The heat-dissipating structures 23 can be extended longitudinally, and are separately disposed on the frame 51. The fixer 52, the frame 51 and the heat-dissipating structure 23 are fastened together by screws. The heat-dissipating structure 23 and the frame 51 are made of Cu, Al, Fe, magnesium alloy, metal, or high thermal conduction material. Additionally, the light-emitting modules of the embodiments of FIGS. 3A and 4B also can be assembled with the frame of FIG. 5A to become an illumination device.

As mentioned above, the illumination device and light-emitting module of the invention fix the heat-dissipating structure and substrate by an elastic element. Thus, the assembly process of the illumination device is simplified. Also, a conventional gap problem caused by miss alignment of holes during the bolt fixing process can be prevented. Additionally, the fixers of the embodiment tightly fix the frame to the heat-dissipating structure to prevent the frame from being bent or curved. Therefore, the heat dissipation effect of the heat-dissipating structure can be further improved.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light-emitting module, comprising:
at least one light-emitting unit;
a substrate allowing the light-emitting unit to be disposed thereon; and
a heat-dissipating structure comprising a recess and at least one protruding portion, wherein the substrate is disposed in the recess, and the protruding portion protrudes out from the recess.

2. The light-emitting module as claimed in claim 1, wherein the protruding portion comprises an oblique surface, and the oblique surface tilts from an outer side of the heat-dissipating structure toward a central portion of the heat-dissipating structure to reflect a light beam emitted from the light-emitting unit.

3. The light-emitting module as claimed in claim 1, wherein the recess comprises a bottom portion and a plurality of side walls, and the protruding portion extends from the side wall toward a central portion of the recess.

4. The light-emitting module as claimed in claim 3, wherein at least one groove is formed among the protruding portion, the bottom portion and the side wall.

5. The light-emitting module as claimed in claim 4, wherein the substrate is attached to the bottom portion of the recess, and a part of the substrate extends to the groove.

6. The light-emitting module as claimed in claim 5, further comprising at least one elastic element, wherein the elastic element is disposed in the groove and located between the protruding portion and the substrate for fixing the substrate.

7. The light-emitting module as claimed in claim 6, wherein the elastic element is a circular or elliptic pillar and made of plastic or rubber.

8. The light-emitting module as claimed in claim 6, wherein the elastic element comprises a bending sheet and a base, the base is disposed on the substrate, and the bending sheet abuts against the protruding portions of the heat-dissipating structure.

9. The light-emitting module as claimed in claim 8, wherein the base comprises a through hole.

10. The light-emitting module as claimed in claim 8, wherein the bending sheet is formed with the base as a monolithic piece, welded to the base, embedded in the base or wedged to the base.

11. The light-emitting module as claimed in claim 5, wherein each of the protruding portions comprises at least one protrusion extending downward from the each of the protruding portions for fixing the substrate, at least one indentation is formed on an upper surface of the protruding portions corresponding to the protrusion, and the protrusion comprises a curved or hemispheric surface shape.

12. The light-emitting module as claimed in claim 1, wherein the light-emitting units are arranged separately along a longitudinal direction of the substrate, and the light-emitting units are LEDs.

13. The light-emitting module as claimed in claim 1, wherein the heat-dissipating structure is an aluminum extrusion heat-dissipating structure, and the heat-dissipating structure comprises a plurality of heat dissipation fins, wherein the heat dissipation fins are disposed on two lateral sides of the recess symmetrically, and the heat dissipation fins extend outward parallel to the substrate.

14. The light-emitting module as claimed in claim 1, wherein the heat-dissipating structure is formed as a monolithic piece, and made of Cu, Al, Fe, magnesium alloy, metal, or thermal conduction material.

15. The light-emitting module as claimed in claim 1, wherein the substrate is a printed circuit board.

16. An illumination device, comprising:
a frame;
at least one light-emitting unit;
at least one substrate, wherein the light-emitting unit is disposed on the substrate; and
at least one heat-dissipating structure disposed in the frame and comprising a recess and at least one protruding portion, wherein the substrate is disposed in the recess, the protruding portion protrude out from the recess.

17. The illumination device as claimed in claim 16, further comprising a fixer disposed on an end of the frame opposite to the heat-dissipating structure.

18. The illumination device as claimed in claim 17, wherein the fixer is disposed on an outer portion of the frame, the fixer and the heat-dissipating structure are respectively mounted on both sides of the frame so that the heat-dissipating structure is attached to a bottom of the frame, and the fixer, the frame and the heat-dissipating structure are fastened together by at least a screw.

19. The illumination device as claimed in claim 16, wherein the heat-dissipating structures are extended longitudinally, and arranged on the frame separately.

20. The illumination device as claimed in claim 16, wherein the heat-dissipating structure and the frame are made of Cu, Al, Fe, magnesium alloy, metal, or thermal conduction material.

21. The illumination device as claimed in claim 16, wherein the protruding portion comprises an oblique surface, and the oblique surface tilts from an outer side of the heat-dissipating structure toward a central portion of the heat-dissipating structure to reflect a light beam emitted from the light-emitting unit.

22. The illumination device as claimed in claim 16, wherein the recess comprises a bottom portion and a plurality of side walls, the protruding portions extend from the side wall toward a central portion of the recess, at least one groove is formed among the protruding portion, the bottom portion and the side wall, the substrate is attached to the bottom portion of the recess, and a part of the substrate extends to the groove.

23. The illumination device as claimed in claim 22, further comprising at least one elastic element, wherein the elastic element is disposed in the groove and located between the protruding portion and the substrate for fixing the substrate.

24. The illumination device as claimed in claim 23, wherein the elastic element comprises a bending sheet and a base, the base is disposed on the substrate, and the bending sheet abuts against the protruding portions of the heat-dissipating structure.

26. The illumination device as claimed in claim 23, wherein each of the protruding portions comprises at least one protrusion extending downward from the each of the protruding portions for fixing the substrate, and at least one indentation is formed on an upper surface of the protruding portions corresponding to the protrusion.
